(19) United States
(12) Patent Application Publication
(10) Pub. No.: US 2020/0150299 A1
(43) Pub. Date: May 14, 2020

(54) COIL-SHOOTING AND STRAIGHT-LINE-RECORDING SYSTEM AND METHOD FOR SEISMIC DATA ACQUISITION

(71) Applicant: CGG SERVICES SAS, Massy Cedex (FR)

(72) Inventor: Risto SILIQI, Paris (FR)

(21) Appl. No.: 16/316,140

(22) PCT Filed: Jul. 12, 2017
(86) PCT No.: PCT/IB2017/001069

§ 371 Date: Jan. 8, 2019

Related U.S. Application Data
(60) Provisional application No. 62/363,373, filed on Jul. 18, 2016.

(51) Int. Cl. G01V 1/00; G01V 1/38; G01V 1/143

(52) U.S. Cl. CPC G01V 1/005; G01V 1/143; G01V 1/3808

(57) ABSTRACT

Method and marine seismic acquisition system that includes an acoustic source towed along an overlapping curved sail path and configured to generate acoustic waves; a first underwater vehicle, UV, that moves along a receiver straight path; and a first seismic receiver attached to the first UV and configured to record the acoustic waves generated by the acoustic source. A receiver position along the straight path is substantially coincident with the overlapping curved sail path at given times.

### BACKGROUND

### Technical Field

Embodiments of the subject matter disclosed herein generally relate to methods and systems and, more particularly, to mechanisms and techniques for acquiring seismic data in a marine environment with a combination of seismic receives located on underwater vehicles (UVs) and source coil-shooting.

### Discussion of the Background

Marine seismic data acquisition and processing generate a profile (image) of a geophysical structure under the seafloor. This image is generated based on recorded seismic data. The recorded seismic data includes pressure and/or particle motion related data associated with the propagation of a seismic wave through the earth. While this profile does not provide an accurate location of oil and gas reservoirs, it suggests, to those trained in the field, the presence or absence of these reservoirs. Thus, providing a high-resolution image of geophysical structures under the seafloor is an ongoing process. The image illustrates various layers that form the surveyed subsurface of the earth.

Reflection seismology is a method of geophysical exploration to determine the properties of earth's subsurface, which is especially helpful in determining the above-noted reservoirs. Marine reflection seismology is based on using a controlled source of energy that sends the energy (seismic waves) into the earth. By measuring the time it takes for the reflections and/or refractions to come back to plural receivers, it is possible to evaluate the depth of features causing such reflections. These features may be associated with subterranean hydrocarbon deposits.

A traditional system 100 for generating seismic waves and recording their reflections off the geological structures present in the subsurface includes a vessel 102 that tows, along a straight path 104, an array of seismic receivers 106 provided on streamers 108 (only one shown for simplicity). The streamers may be disposed horizontally, i.e., lying at a constant depth relative to the ocean surface 111. The streamers may have other than horizontal spatial arrangements. The vessel also tows a seismic source array 110 configured to generate seismic waves 112. The seismic waves propagate downward and penetrates the seafloor 114 until eventually a reflecting structure 116 (reflector) reflects the seismic wave. The reflected seismic wave 118 propagates upward until detected by the receiver(s) 106 on the streamer(s) 108. The data collected by the receiver(s) is processed with a computing device and an image of the subsurface is generated.

In the configuration illustrated in FIG. 1, the seismic source moves along the straight path 104 until arriving at a border 120A of the seismic survey area 120 (see FIG. 2A), after which the source and the vessel turn around along a curved path 104A and advance along another straight path 122. An alternative to this straight-line shooting is the coil-shooting, in which path 104 is a curved path as shown in FIG. 2B and the vessel 102 and source 110 move along the curved path. Because the curved path is similar to a coil having plural turns, the curved path is understood herein to be an overlapping curved sail path that includes plural turns. In one application, the overlapping curved sail path includes trochoidals.

However, the traditional seismic acquisition configurations shown in FIGS. 2A and 2B are expensive because the cost of the streamers is high. Further, due to the great length of the streamers, e.g., 10 km, the streamer array is difficult to maneuver around various obstacles, e.g., an oil platform or over along the coil.

New technologies deploy plural seismic sensors to the bottom of the ocean (ocean bottom stations) to avoid this problem. Even so, positioning the seismic sensors remains a challenge. Such technologies use permanent receivers set on the ocean bottom, as disclosed in U.S. Pat. No. 6,932,185, the entire content of which is incorporated herein by reference. In this case, the seismic sensors are attached to a heavy pedestal.

Although the ocean bottom nodes better handle the various obstacles present in the water, using them is still expensive and difficult because the sensors and corresponding pedestals are left on the seafloor. Further, positioning the ocean bottom nodes is not straightforward.

An improved approach to these problems is the use of plural (e.g., thousands) autonomous underwater vehicles (AUVs) for carrying the seismic sensors and collecting the seismic data. The AUVs may be launched from a deployment vessel, guided to a final destination in the ocean, instructed to record the seismic data, and then instructed to surface for retrieval. Such a system is disclosed in U.S. Pat. No. 9,417,351, which is assigned to the assignee of the present application. However, many challenges remain with the use of a large number of AUVs for collecting seismic data given that the source moves with a much higher speed than the AUVs. For example, in a typical seismic survey that uses AUVs and sources moving along straight paths, the AUVs moves with about 0.4 knots (due to their limited power capabilities) while the source moves with about 4-5 knots.

Accordingly, it would be desirable to have systems and methods that better coordinate the positions of underwater receivers participating in a seismic survey with the position of the source(s).

### SUMMARY

According to an embodiment, there is a marine seismic acquisition system that includes an acoustic source (S) towed along an overlapping curved sail path and configured to generate acoustic waves; a first underwater vehicle, UV, that moves along a receiver straight path; and a first seismic receiver (R) attached to the first UV and configured to record the acoustic waves generated by the acoustic source (S). A receiver position along the straight path is substantially coincident with the overlapping curved sail path at given times.

According to another embodiment, there is a method for selecting a geometry of a marine acquisition system for performing a marine seismic survey. The method includes receiving a maximum offset between a source (S) and a receiver (R) of a swarm of receivers; calculating a size of a shooting turn based on the maximum offset, wherein the source moves along an overlapping curved sail path and the receiver moves along a straight path so that the receiver intersects the overlapping curved sail path at given times; calculating a length of the swarm based on a speed of the receiver and a speed of the source; calculating a shooting rate of the source and a distance between adjacent receivers in the swarm based on a depth of a seismic target; calculating the number of receivers in the swarm based on the distance between adjacent receivers; and calculating a position of a center of the swarm to coincide with an entry point of the source for each turn of the overlapping curved sail path.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a traditional marine seismic acquisition system that uses a vessel to tow a source and plural streamers;

FIG. 2A illustrates straight paths followed by the source and streamers from FIG. 1;

FIG. 2B illustrates a curved path followed by the source and streamers from FIG. 1;

FIG. 3 illustrates the offset and azimuth of a source and a receiver;

FIGS. 4A-4C illustrate the various possible paths of a source and receiver that perform a seismic survey;

FIG. 5 illustrates the illumination for a coil-shooting straight line-receiver marine acquisition system;

FIGS. 6A and 6B illustrate the influence of the receiver speed on the illumination's shape;

FIGS. 7A-7C illustrate the influence of the location of the receiver relative to the source's coiling path in terms of offset and azimuth;

FIGS. 8A-8C illustrate the influence of the receiver's speed on the illumination density;

FIG. 9 illustrates the coordination between the receiver's positions for those instances when the source enters a new turn of the curved path;

FIG. 10 illustrates the same coordination for a swarm of receivers;

FIGS. 11A and 11. B illustrate a coil-shooting source and four swarms of receivers distributed symmetrically along the turn;

FIG. 12 shows the locations of the four swarms around the turn so that a center location of each swarm coincides with a location of the source when the swarm traverses the turn;

FIG. 13 illustrates the sizes of vertically and horizontally distributed swarms relative to a turn of the source;

FIG. 14 illustrates the relationships between centers of turns distributed next to each other in a same swath and adjacent swaths of the seismic survey;

FIG. 15 illustrates a coil-shooting straight-line-recording marine system;

FIG. 16 shows a coil-shooting straight-line-recording marine system having curved swarms;

FIG. 17 show a coil-shooting straight-line-recording marine system having a variable density of receivers depending on the location of the source relative to the swarm;

FIG. 18 is a schematic illustration of an AUV;

FIG. 19 is a schematic diagram of a computing device that performs one or more of the methods noted above; and

FIG. 20 is a method for designing a seismic survey that uses a coil-shooting straight-line-recording marine system.

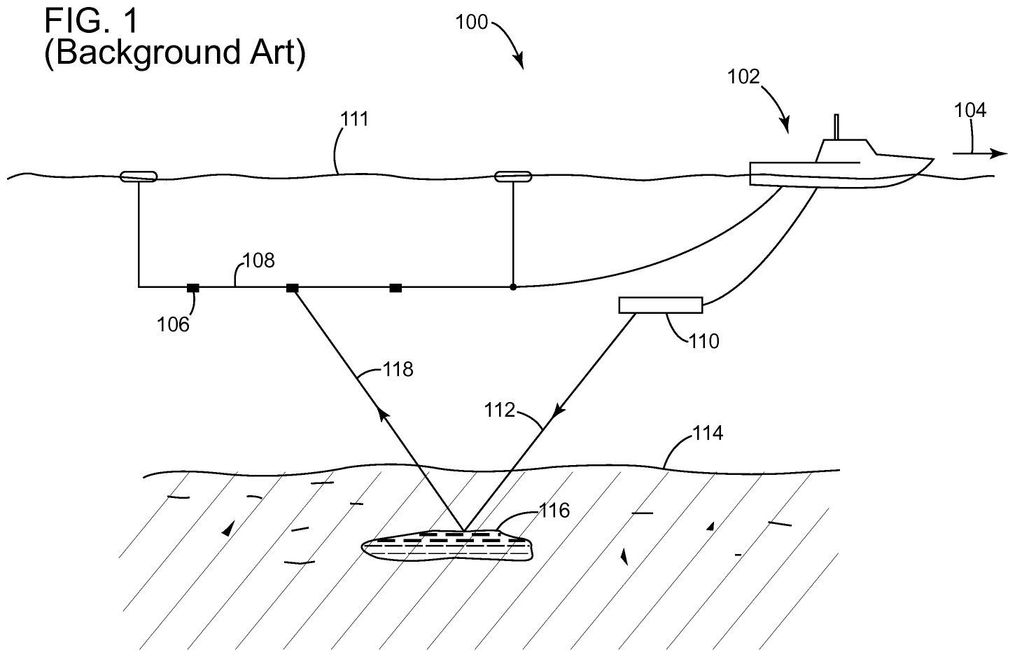

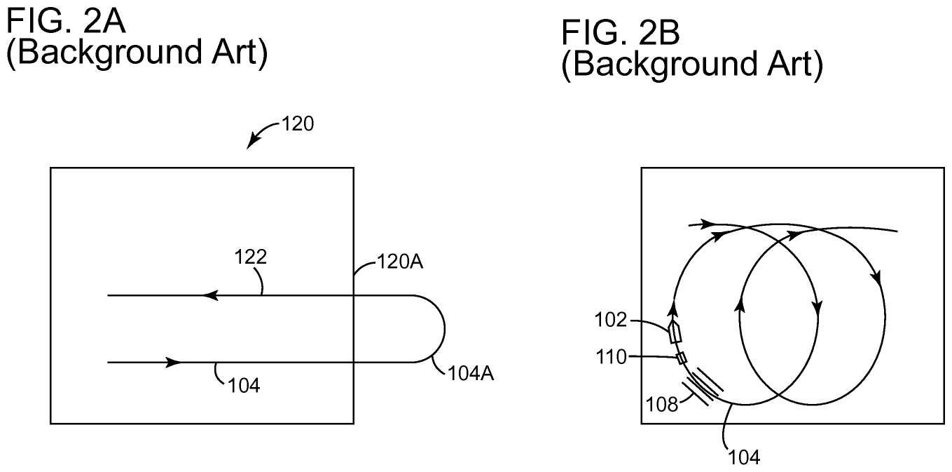

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of plural UVs forming a swarm. However, the embodiments to be discussed next are not limited to swarms of UVs, but may be applied to a line of UVs or even to a single UV. Note that an UV may be an AUV or a remotely operated vehicle (ROV). For simplicity, in the following, the embodiments are discussed with regard to one or more AUV. However, those skilled in the art would understand that the teachings of these embodiments also apply to other UVs.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, the AUVs being independent of each other and also being able to move independently from the sources, allow an unexpected flexibility for the geometry of the seismic data acquiring system. Acquisition systems with sources and receivers moving independently of each other are suitable for acquiring seismic data with rich distribution of offsets and azimuth. The illumination effect of the receiver distribution could be controlled either mechanically by the actuation mechanism of the AUV or by the source path's geometry.

To prevent the receivers from recording flow noise associated with the AUVs' movement in water in addition to the acoustic signals reflected from the subsurface, the AUVs' moving direction may be selected to not to be against the ocean currents. In one application, the AUVs follow the water current. To honor these goals of a seismic survey, the geometry of the source's path can be selected to control the full-azimuth of the source-receiver and the required offset distribution from the minimum to the maximum values (which are typically given prior to the survey). In other words, for any seismic survey, the azimuth (angle between the source-receiver direction and the movement direction) and offset distribution (distance between the source and the receivers) have to have some minimum values and these values can be controlled with the geometry of the system. As will be discussed later in more detail, improved azimuth and offset distribution values (i.e., good illumination seismic data) may be obtained with AUVs that move tangent to the turns (which are approximated by circular paths) of the sources or with lines of AUVs that extend tangent to the turns or with swarm of AUVs having a length that is tangent with the one or more turns at least for a given time. In this embodiment, the diameter of the turn controls the maximum of the offsets, the tangent trajectory of the receivers to the plural turns controls the near-offsets, and the coil-shooting controls the full azimuth aspect.

In one application, the moving direction of the AUV swarm is chosen to “align” with the existing ocean currents and the speed and their size is customized so that the swarm is aligned with the source for the next shooting turn. In one application, several swarms are deployed along the turn to increase so that corresponding lengths of each swarm are tangent to the turn of the source at given times. This configuration allows a better distribution of near-offsets and makes the acquisition more efficient. By following the ocean current's direction from one side of the survey area to the other, a full swath may be acquired. The next swath may be planned conform to the required illumination coverage and optimum efficiency as discussed later. The acquired trace density could be controlled by the size of the swarms and overlaps of the turns in all directions.

Impulsive or vibratory acoustic sources may be used for this acquisition. The sources may be towed by streamer or source vessels or installed in autonomous vehicles (e.g., AUVs, barges, etc.). The AUVs may drift with the ocean currents or could be driven by an integrated actuation mechanism (e.g., propellers or water pumps) to remain static or to move toward a pre-defined target. The AUVs may be deployed in various formations (e.g., lines, swarms) and controlled either from a vessel or from a master AUV, to preserve a predefined geometry.

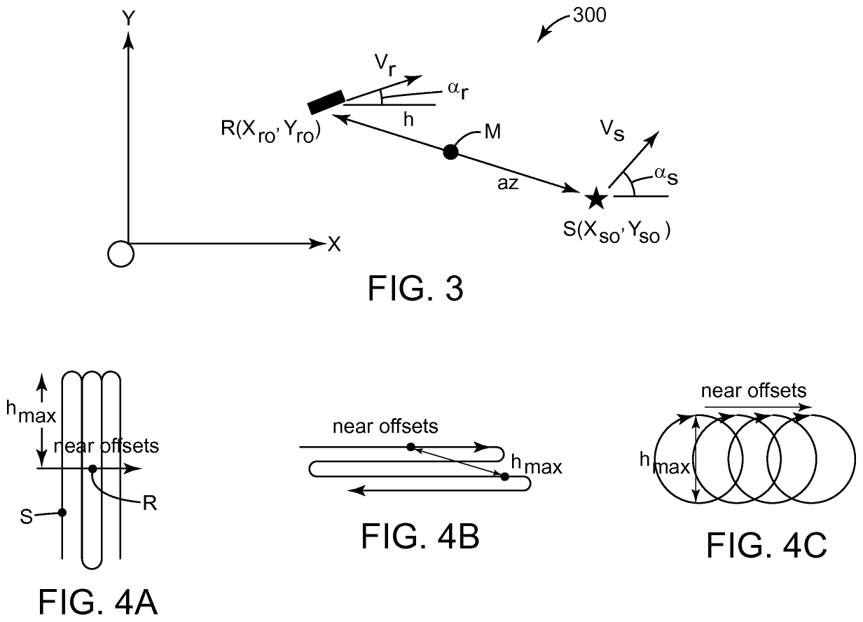

Prior to discussing specific configurations of an acquisition system that includes independent AUVs and independent sources, a mathematical formalism describing the characteristics of this system is now introduced. FIG. 3 shows a receiver R and a marine acoustic source S (an acoustic source is a device that generates acoustic waves underwater) having local coordinates (xᵣₒ, yᵣₒ) and (xₛₒ, yₛₒ), respectively, in a system of reference XOY. The receiver R moves with a speed vᵣ(t) at an angle αᵣ relative to axis X and the source S moves with a speed vₛ(t) at an angle αₛ relative to axis X. Thus, the coordinates (xᵣ(t), yᵣ(t)) of the receiver R at a given time t and the coordinates (xₛ(t), yₛ(t)) of the source S at the same given time t are given by:

xᵣ(t)=xᵣₒ+vᵣ(t)·t·cos αᵣ(t)

yᵣ(t)=yᵣₒ+vᵣ(t)·t·sin αᵣ(t)

xₛ(t)=xₛₒ+vₛ(t)·t·cos αₛ(t)

yₛ(t)=yₛₒ+vₛ(t)·t·sin αₛ(t). (1)

Based on equations (1), the offset of the source S and receiver R at any time t is given by:

hₓ(t)=(xₛₒ−xᵣₒ)+(vₛ(t)·cos αₛ(t)−vᵣ(t)·cos αᵣ(t))·t

h_{y}(t)=(yₛₒ−yᵣₒ)+(vₛ(t)·sin αₛ(t)−vᵣ(t)·sin αᵣ(t))·t, (2a)

and the azimuth of the source S-receiver R at any time t is given by:

$$h ( t ) = \sqrt{{h}_{x}^{2} + {h}_{y}^{2}} and az ( t ) = {tan}^{- 1} \frac{{h}_{y}}{{h}_{x}} . \qquad ( 2 b )$$

According to an embodiment, the acquisition system 300 including the source S and receiver R in FIG. 3 would provide appropriate seismic data if the offset h(t) does not exceed a maximum required seismic offset (hₘₐₓ). If the offset h(t) reaches the maximum seismic offset, the source or the receiver or both of them have to be repositioned to not violate the maximum value.

Another requirement for the acquisition system 300 is the illumination footprint (or illumination imprint) of the source-receiver pair. As a first approximation, the illumination imprint for the pair R and S shown in FIG. 3 is controlled by the projection of the mid-point M, which has the coordinates (xₘ, yₘ). These coordinates are given by:

xₘ(t)=½(xₛₒ−xᵣₒ)+½(vₛ(t)cos αₛ(t)+vᵣ(t)cos αᵣ(t))·t, and

yₘ(t)=½(yₛₒ−yᵣₒ)+½(vₛ(t)sin αₛ(t)+vᵣ(t)sin αᵣ(t))·t. (3)

For a given seismic survey, the mid-points of all source-receiver pairs should fall into the predefined survey area and the footprint of all the mid-points form the illumination imprint.

If independent sources and independent AUVs are considered forming the marine seismic acquisition system, various geometries of the marine seismic acquisition system may be imagined. Because the AUVs move slower than the sources and they have a limited amount of power available, there is more freedom for the source's path than the AUV's paths. FIGS. 4A-4C illustrate three different configurations for such a system. Note that the term receiver is understood to include one or more physical receivers, e.g., a swarm of receivers. The term source is understood herein to include one or more single source elements, e.g., a source array. The term source may also include multiple-sources such as dual-source, triple-source etc., which could be also widely towed.

The first configuration, illustrated in FIG. 4A, is a perpendicular configuration in which the source and the receivers move perpendicular to each other. Navigating the source S perpendicular to the direction of the movement of receivers R limits the source's paths to the maximum hₘₐₓ of the offsets. Under these conditions, the speed of the receivers could be low enough, just allowing the receiver to self-redeploy for the next source path. In the special case in which the AUV is static, this configuration corresponds to a land acquisition type of geometry. Shooting the source while moving perpendicular to the receiver's movement is suitable for acquiring narrow azimuth type of seismic data (NAZ).

The second configuration, which is illustrated in FIG. 4B, is a parallel configuration in which the source and the receivers move parallel to each other. The length of the lines along which the sources move is limited by the speed difference between the source and receivers. The offsets between the source and receivers can be expressed as:

hₓ(t)=xₛₒ−xᵣₒ+(vₛ±vᵣ)·t

h_{y}(t)=yₛₒ−yᵣₒ, (4)

where the plus/minus sign accounts for the source and receiver relative moving directions (i.e., they move in the same direction or in opposite directions). The length of the source's path is controlled by the maximum value of the offsets.

This means that when both the source and receivers move along the same direction, the higher the speed of the receivers, the longer will be the line navigated by the source, thus, assuring the acquisition of offsets smaller than the maximum required. Under the specific condition when both the source and receivers speeds are identical, this configuration is equivalent to a marine towed streamer acquisition system.

When the source and receivers move in opposite directions, the lower the speed of the receivers, the longer would be the source line for acquiring acceptable offsets. This propriety has to be taken into consideration when optimizing the efficiency of this type of geometry.

The mid-point M sample interval Δxₘ is also sensitive to the difference in speed of the source-receivers and especially to their directions, as illustrated by the following relation:

Δxₘ=½(vₛ±vᵣ)·Δtₛ, (5)

where Δtₛ is the shooting rate of the source.

If maintaining the mid-point M density is a strong requirement of the seismic survey, then it is necessary to make dynamic adjustments of vₛ, yᵣ or Δtₛ. These adjustments could be important for preserving the same mid-point grid regardless of the shooting back and forth of the source relative to the direction of moving receivers (the effect of ± sign in equation (5)).

In some embodiments, this flexibility could be used to create jitters in the mid-point distribution, which are necessary for the deployment of simultaneous sources, avoidance of seismic interference noises or pre-conditioning for regularization schemes.

If the cross-line distance between the source line and the receiver line remains less than a typical spread of marine streamers, this type of acquisition provides NAZ type of seismic data. This type of acquisition could be generalized to undulated source lines, in the same way as it is proposed in Patent Application Publication No. US 2013/0188448, which is incorporated herein in its entirety and is assigned to the Assignee of this application.

The third configuration, which is shown in FIG. 4C, is a mixed configuration in which the source moves along a curved path and the receivers move along straight paths. For this embodiment, it is assumed that a vessel tows the source along a circle or turn and the source generates a seismic signal at each Δtₛ. A swarm of receivers moves along a straight line and records the reflected wavefield from the subsurface. This system is called a coil-shooting straight-line-recording system. The source's path is chosen in this embodiment to be a circle for mathematical simplicity. However, the same concepts to be discussed next work for other types of source paths, as long as the paths are overlapping curved sail paths. Thus, in the following, the term “overlapping curved sail path” is a path that includes plural turns that overlap with themselves multiple time. Each turn is assumed for simplicity to be a circle although in reality the turn is a deformed circle.

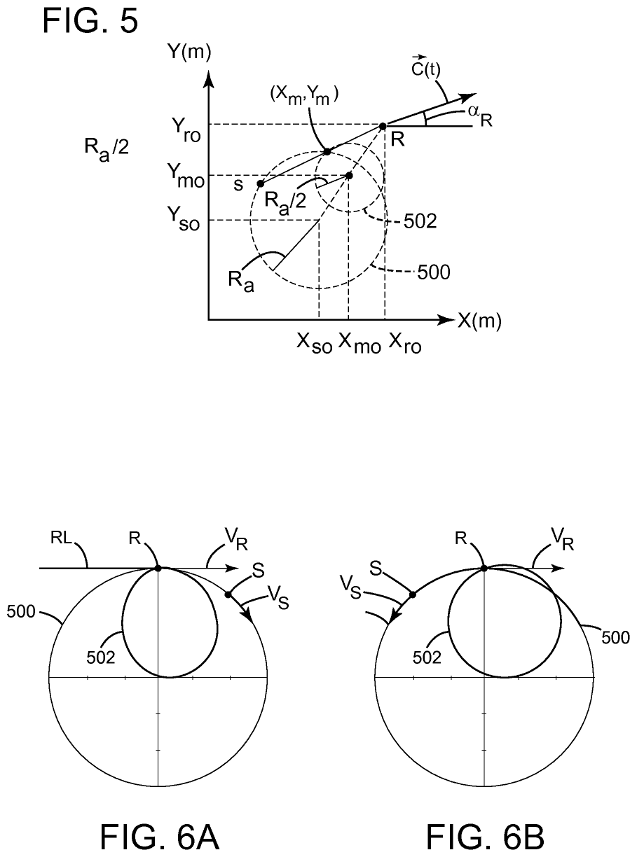

For this embodiment, the source's path is a circle 500 (see FIG. 5) having a predefined radius Rₐ and center (xₛₒ, yₛₒ). The parametric equation of the source's position at a given time t along the circle 500, starting from an initial position (xᵣₒ, yᵣₒ), is the following:

$${x}_{s} ( t ) = {x}_{so} + {R}_{a} cos ( \pm \frac{{v}_{s} t}{{R}_{a}} + {α}_{i} ) \\ {y}_{s} ( t ) = {y}_{so} + {R}_{a} sin ( \pm \frac{{v}_{s} t}{{R}_{a}} + {α}_{i} ) , \qquad ( 6 )$$

with time t being in the interval

$$( 0 , \frac{2 π {R}_{a}}{{v}_{s}} ) ,$$

the plus/minus sign is related to the rotation of the source clockwise or anticlockwise, and angle alpha describes the angle of the source S relative to axis X. During the time that the source S rotates along the circle 500, the receiver R moves in water, as also illustrated in FIG. 5, from its initial position xᵣₒ, yᵣₒ, with a speed vᵣ(t), along a direction \vec{C}(t), which makes an angle αᵣ with the axis X. Both the speed vᵣ(t) and direction \vec{C}(t) can change in time. The speed and the direction may be determined as a combination of the ocean currents and receiver AUV's propulsion, as described by the following equations:

xᵣ(t)=xᵣₒ+Cₓvᵣ(t)·t,

yᵣ(t)=yᵣₒ+C_{y}vᵣ(t)·t, (7)

with time t being in the interval

$$( 0 , \frac{2 π {R}_{a}}{{v}_{s}} ) .$$

Still with regard to FIG. 5, the illumination imprint (or mid-point geometry) of the source S that follow circle 500 and receiver R that moves with a certain speed vᵣ(t), along a direction \vec{C}(t) is given by:

$${x}_{m} ( t ) = \frac{{x}_{so} + {x}_{ro} + {C}_{x} ( t ) {v}_{r} ( t ) \cdot t}{2} + \frac{{R}_{a}}{2} cos ( \pm \frac{{v}_{s} t}{{R}_{a}} + {α}_{i} ) \\ {y}_{m} ( t ) = \frac{{y}_{so} + {y}_{ro} + {C}_{y} ( t ) {v}_{r} ( t ) \cdot t}{2} + \frac{{R}_{a}}{2} sin ( \pm \frac{{v}_{s} t}{{R}_{a}} + {α}_{i} ) \qquad ( 8 )$$

with time t being in the interval

$$( 0 , \frac{2 π {R}_{a}}{{v}_{s}} ) .$$

For the case of a stationary receiver R, i.e., vᵣ(t)=0, the mid-point M between the source S and the receiver R follows a circle 502 (or mid-point distribution) having half the radius Rₐ of the source's path 500, i.e., R/2, when the source S moves around circle 500. With respect to FIG. 5, it is noted that the distance between turn 500's center and the receiver R does not change the mid-point geometry. However, the speed of the receiver slightly affects the shape of the mid-point distribution 502, as illustrated in FIGS. 6A and 6B. In this respect, FIG. 6A shows the shape of the mid-point distribution 502 when the receiver R and source S have the same direction at the top of path 500 and FIG. 6B shows the shape of the mid-point distribution 502 when the source and receiver's speeds have opposite directions at the top of path 500. Note that generally the speed of the source (about 2 to 3 m/s) is far superior to the speed of the receiver (0.2 m/s if drifting or 0.8 m/s with propulsion).

The arrangement in FIG. 6A has some advantages, e.g., denser illumination near the receiver line RL (near-offsets), and the source vessel exits from the turn at the same direction as the receiver moves, which is important for shooting the next turn.

The offset and azimuth distribution are now calculated for a seismic acquisition system that has a source moving along an overlapping curved sail path (a circle in this embodiment for simplicity) and a receiver that moves along a straight line. The distance between the source S and the receiver R is given by:

$${h}_{x} ( t ) = R \cdot ( \frac{{x}_{so} - {x}_{ro} - {C}_{x} ( t ) {v}_{r} ( t ) \cdot t}{{R}_{a}} + cos ( \pm \frac{{v}_{s} t}{{R}_{a}} + {α}_{i} ) ) \\ {h}_{m} ( t ) = R \cdot ( \frac{{y}_{so} - {y}_{ro} - {C}_{y} ( t ) {v}_{r} ( t ) \cdot t}{{R}_{a}} + sin ( \pm \frac{{v}_{s} t}{{R}_{a}} + {α}_{i} ) ) \qquad ( 9 )$$

with time t being in the interval

$$( 0 , \frac{2 π {R}_{a}}{{v}_{s}} ) .$$

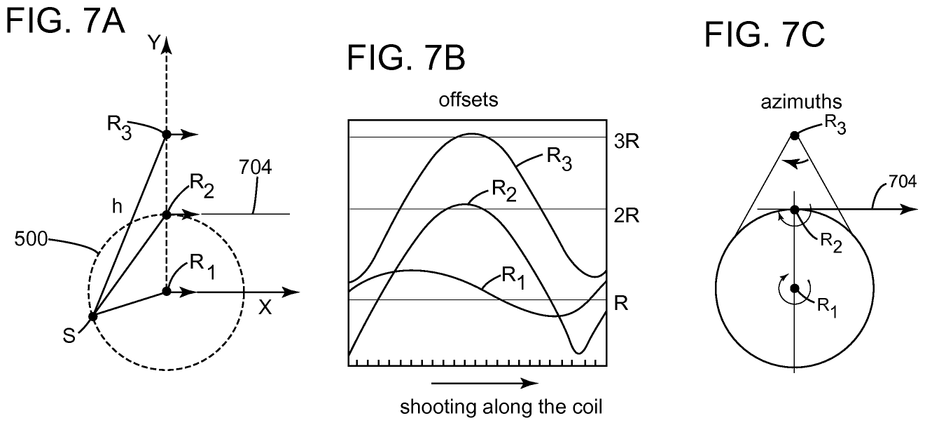

The offset vector (hₓ, h_{y}) can be used to calculate the full offset and azimuth, based on equation (2b). The offset distribution, calculated based on equations (9), has a sinusoidal behavior, shifted and modulated by the distance of the receiver from the source turn, as illustrated in FIG. 7B. FIG. 7A shows three situations, receiver R₁ is located at the center of the source S's path 500, receiver R₂ is touching turn 500 and has a trajectory 704 tangent to turn 500, and receiver R₃ is located outside turn 500. Note that source S moves and shoots along turn 500 while the receivers move along paths parallel to the X axis. FIG. 7B shows corresponding offset distributions for the three receivers R₁ to R₃ and FIG. 7C shows the azimuths for the three receivers.

A distance between the receiver and the turn represents the minimum acquired offset (zero for R₂) and this distance is calculated when the source is on top of path 500. Note that for either R₁ or R₃, the minimum acquired offset is larger than zero and in fact is equal to the radius Rₐ of turn 500.

In terms of the azimuths, FIG. 7C shows that the receiver R₃ outside the path 500 can achieve a limited azimuth while the receiver R₁ located inside the path 500 can acquire a full azimuth. Receiver R₂, which moves along path 704, which is tangent to the path 500, achieves half full azimuth. However, those skilled in the art would note that by moving receiver R₂ slightly inside path 500 or by adding some additional receivers around receiver R₂, to have a swarm of receivers, a full azimuth distribution can easily be achieved.

From these calculations and considerations, it is observed that an optimum case of receiver deployment, for a source that follows an overlapping curved sail path, is to instruct the receiver to move along a tangent of the overlapping curved sail path 500 of the source. In this way, the acquired seismic data has a full azimuth and full offset. In one embodiment, the receiver's path may not be tangent to the overlapping curved sail path, but rather the receiver moves in such a way that is substantially coincident with the sail path at a given time.

According to another embodiment, it is possible to use plural receivers (i.e., a swarm of receivers), instead of a single receiver as previously discussed, that record seismic data generated by a source that moves along an overlapping curved sail path. For this embodiment, consider a swarm 710 of receivers R moving along a line 712, which is tangent to the path 700 of the source S. Note that the swarm 710 may also move along a north-south direction in the figure and a length of the swarm is tangent to the path 700 of the source S at a given time. The swarm of receivers are arranged along line 712. The swarm 710 has its center 716 located at the initial location 714 of the source S as illustrated in FIG. 8A. As source S moves along the path 700 with its speed vₛ, the line of receivers (the swarm) moves with speed vᵣ along line 712. By the time the source S has performed one full loop around path 700, the line of receivers 710 has advanced so that the center 716 of the swarm 710 is at position 714′. FIG. 8A also shows the trajectories 718 of the mid-points M between each receiver R of the swarm 710 and source S, as both the swarm and the source advance along their paths.

FIG. 8B shows the same but for a smaller speed of the swarm and FIG. 8C also shows the same as FIG. 8A, but for a stationary swarm (i.e., vᵣ=0). It is noted that moving faster reduces the area of the illumination imprint, but increases the density of the traces and makes it more uniform. When the source makes a full turn, each receiver is translated a distance along the tangent 712 according to its speed, the distance being given by:

$${x}_{r} - {x}_{ro} = 2 π {R}_{a} \frac{{v}_{r}}{{v}_{s}} . \qquad ( 10 )$$

As previously discussed, path 700 is considered to be a circle for simplicity. In reality, turn 700 is an overlapping curved sail path. This means that source S needs to move from turn 700 shows in FIG. 8A to a next turn and the time for this needs to be taken into account when calculating a synchronization between the swarm and the source. In other words, it is desired that the initial location 714 of source S, for each turn 700, coincides with the center 716 of the swarm 710. To achieve this synchronization, it is necessary that the time spent by the center 716 of the swarm to advance from one location 714 to the next one 714′ is equal to the time spent by the source S to fully move around path 700 and then to advance to the next location 714′, to meet the center 716 of the swarm. After taking into account the above considerations, the distance travelled by the swarm from position 714 to 714′ is given by:

$${x}_{r} - {x}_{ro} = 2 π {R}_{a} \frac{{v}_{r}}{{v}_{s} - {v}_{r}} . \qquad ( 11 )$$

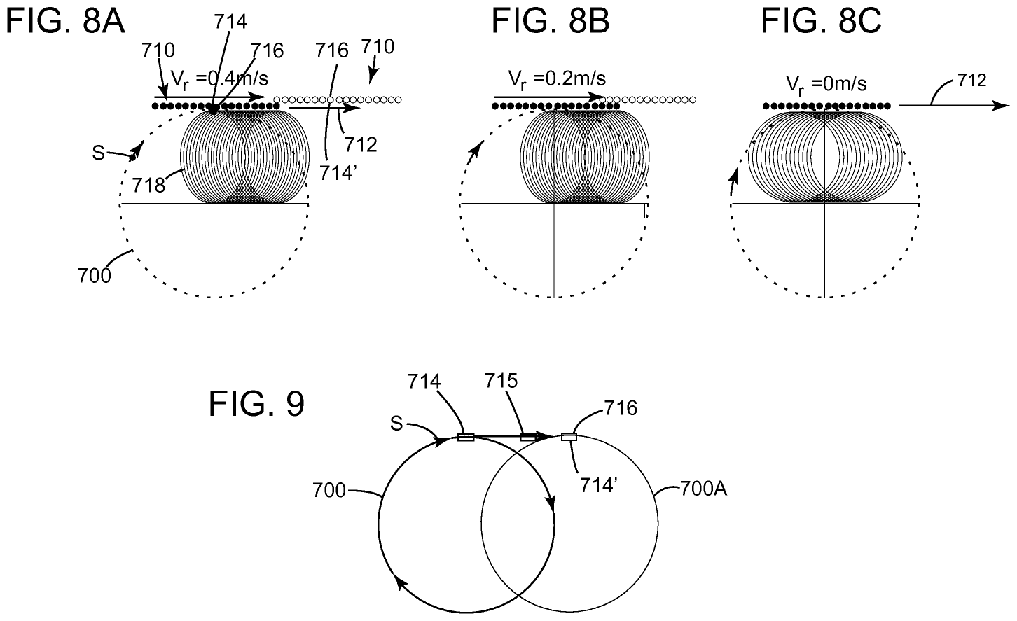

With this equation, the initial location 714 at time T₀, the position 715 of the source S when exiting turn 700 at time Tₜᵤᵣₙ, and the next location 714′, when the center 716 of the swarm 710 coincides again with another initial location 714′ of source S for the next turn 700A, are shown in FIG. 9. Note that path 712 of swarm 710 is tangent to both turns 700 and 700A in this configuration.

An optimized length of the swarm 710 (along direction 712) may be calculated based on equation (11). This means that the length L of the swarm would be equal to the redeployment distance of the source (i.e., the distance between two adjacent positions 714 and 714′ in FIG. 9).

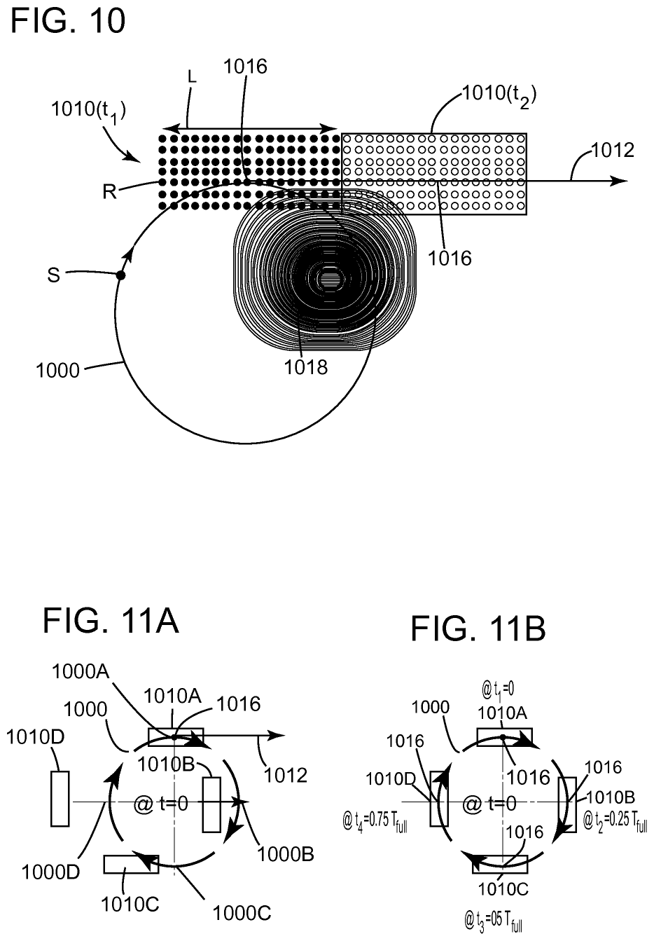

According to another embodiment, in order to achieve more offset/azimuth diversity for the area to be surveyed (illuminated), several parallel lines of receivers (the swarm 710 in FIG. 8A) may be used. More specifically, as illustrated in FIG. 10, a swarm 1010 includes plural parallel lines of receivers R. Those skilled in the art would understand that receivers R inside the swarm may be arranged in any way, not only along straight lines. The entire swarm moves with a speed vᵣ, the speed of a receiver. The entire swarm moves along a line 1012 (swarm path), which is tangent to the source's path 1000. For simplicity, path 1000 is shown to be a circle. However, path 1000 is an overlapping curved sail path. FIG. 10 also shows that a central point 1016 of the swarm 1010 (where the central point is defined as the geometrical center of the area defined by the swarm) coincides with the point where swarm path 1012 is tangent to source path 1000. Those skilled in the art would understand that the term “coincides” is used in a loose sense herein because due to the ocean currents, the central point 1016 may be within 100 m of the tangent point and still be considered to be coincident. The geometry of the illumination imprint 1018 will be similar to that shown in FIG. 8A, but the offset/azimuth distribution (density) is increased due to the larger number of receivers that are part of the swarm. In one embodiment, the number of receivers being part of the swarm may be between 2 and 100. Other numbers may be used.

FIG. 10 shows the swarm 1010 at an initial time t1, when source source S is starting to follow turn 1000, and at a later time t2, when source S has completed turn 1000 and traveled to the next turn, i.e., it is ready to start the new turn. This configuration appears to obtain the best offset/azimuth distribution as there are receivers both inside and outside the path 1000, and some receivers are located along the tangent path 1012.

To further improve the offset/azimuth configuration of FIG. 10, according to yet another embodiment, more than one swarm may be located along the source's path, as illustrated in FIGS. 11A and 11B. These figures show four different swarms located along a turn of curved path 1000. Those skilled in the art would understand that more or less swarms may be used. The four swarms are distributed, in this embodiment, with an angle offset of 90° degrees from each other. In still another embodiment, the four swarms are so located to sequentially meet the source S, along a single turn 1000. This means that a central point 1016 of each swarm substantially coincides (within 100 m) with the source S at various times along a single turn. In the case of perpendicular swarms 1010B and 1010D, the coincidence of swarms with the source moving along the circle is understood to mean that a length of the swarm is tangent to the source's path, in the same way as the tangency of parallel swarms 1010A and 1010C to the source path.

As illustrated in FIG. 11A, the position of each swarm is offset along traveling path 1012 with a different predetermined distance so that as the source S moves around turn 1000 with speed vₛ, and each swarm moves along path 1012 with speed vᵣ, each swarm travels its corresponding predetermined distance to meet the source S. While FIG. 11A shows the locations of the swarms for a same given time, FIG. 11B shows the coincident locations of the swarms with the source at the different times. In other words, the configuration illustrated in FIG. 11B is not taken at a single given time, but it is a superposition of the four swarms taken at four different times.

With regard to FIG. 11A, the first swarm 1010A is centered at the initial location of the source S along path 1000, the second swarm 1010B is deployed with a shift of

$$- {R}_{a} ( \frac{π}{2} \frac{{v}_{r}}{{v}_{s}} - 1 )$$

along path 1012, relative to point 1000B of path 1000, the third swarm 1010C is deployed with a larger shift of

$$- {R}_{a} ( π \frac{{v}_{r}}{{v}_{s}} )$$

along path 1012, relative to point 1000C of path 1000, and the fourth swarm 1010D is deployed with an even larger shift of

$$- {R}_{a} ( 1 + \frac{3 π}{2} \frac{{v}_{r}}{{v}_{s}} )$$

along path 1012, relative to point 1000D of path 1000. Points 1000A to 1000D are angularly shifted by 90° degrees to each other and point 1000A is the point where swarm path 1012 is tangent to source path 1000. FIG. 11B shows that first swarm 1010A meets source S at a first time t₁=0, second swarm 1010B meets source S at a second time t₂=0.25 T_{full}, where T_{full} is the time necessary for the source to fully move around turn 1000, third swarm 1010C meets source S at a third time t₃=0.5 T_{full}, and fourth swarm 1010D meets source S at a fourth time t₄=0.75 T_{full}.

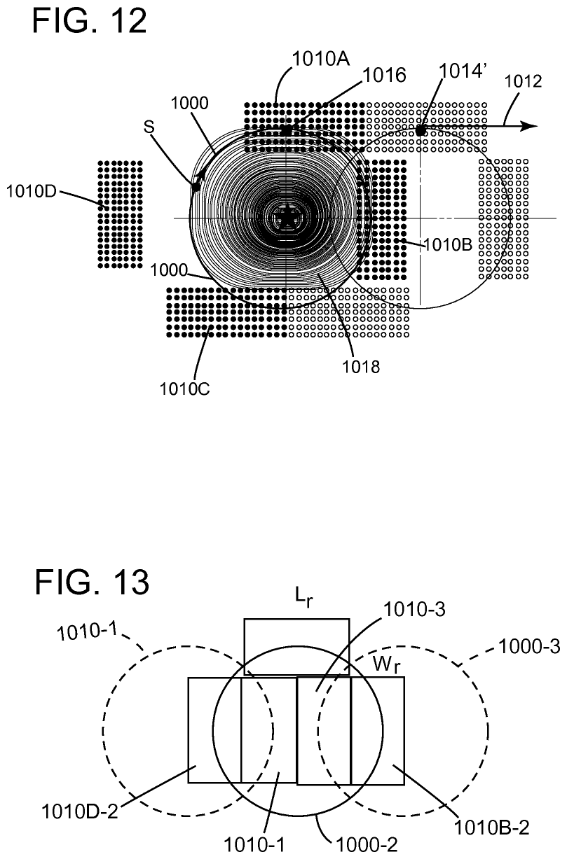

By using the configuration shown in FIGS. 11A and 11B, a better distribution of the near-offsets is achieved and the illumination imprint is extended to cover the entire path 1000, as illustrated in FIG. 12. FIG. 12 also shows the positions of the four swarms when the source S arrives at the next entry position 1014′ for the next turn.

The previous embodiments have examined various characteristics of a marine seismic data acquisition system that includes at least one source that moves along an overlapping curved sail path and at least one receiver that moves along a straight path that is tangent to the overlapping curved sail path of the source. These characteristics are now summarized and quantified for such a coil-shooting straight-line-recording system. Although the embodiments discussed above have exploited the independence of the receivers, the novel concepts may also be applied to receivers located on streamers, as the streamer spread forms the swarm.

Those skilled in the art would know that for any marine seismic survey, some parameters are given, such as the maximum offset between the source and receiver, the speed of the vessel towing the source, the speed of the AUVs carrying the receivers, the receiver separation requirement (i.e., the desired distance between adjacent receivers), the area to be surveyed, etc. These parameters are dictated by the type of survey (deep, shallow) and/or the requirements of the company ordering the survey. Thus, these parameters are fixed at the beginning of the seismic survey planning.

For a given maximum required offset hₘₐₓ, the radius Rₐ of the overlapping curved sail path (the radius of each turn making this curved sail path) is given by

Rₐ=½hₘₐₓ. (12)

The time to shoot the entire turn 1000 of the source S can be determined based on the source speed vₛ and whether a clean record length is required or not as follows:

$${t}_{s} = \frac{2 π {R}_{a}}{{v}_{s}} . \qquad ( 13 )$$

The length Lᵣ of the swarm that works in tandem with the source may be determined, for example, based on the requirement that the swarm's central point fully translates from a first entry position of the source for a first turn to a second entry position of the source for a second turn and the first and second positions determine the tangent swarm path. According to these requirements, the length Lᵣ of the swarm is given by:

$${L}_{r} = 2 π {R}_{a} \frac{{v}_{r}}{{v}_{s} - {v}_{r}} . \qquad ( 14 )$$

A width Wᵣ of a swarm can also be calculated as now discussed with regard to FIG. 13. This figure shows three different turns 1000-1, 1000-2 and 1000-3 that are followed by the source S at different successive times. As discussed above, the swarms are designed to meet the source for each turn at four positions, as illustrated in FIGS. 11A and 11B. If more or less swarms are used, than the number of meeting positions changes accordingly.

FIG. 13 shows that the source, when following the first turn 1000-1, needs to meet swarm 1010-1. The same source when following the second turn 1000-2 needs to meet swarms 1010B-2 and 1010D-2, and the same source when following the third turn 1000-3 needs to meet swarm 1010-3. These swarms will achieve a full coverage of the area traveled by the source if:

$${W}_{r} = \frac{{L}_{r}}{2} . \qquad ( 15 )$$

In one application, all swarms have the same length and width. However, it is possible to have different lengths and widths for the swarms to improve the illumination efficiency.

Another parameter that may be calculated for the coil-shooting straight line-recording marine system is the number of receivers for a given swarm. The receiver separation Δr is traditionally known before the survey. The receiver separation is the distance between two adjacent receivers and this parameter depends on the depth of the surveyed subsurface, the type of subsurface, etc. Based on this data, the number of receives is n_{Lr}×n_{Wr}, where n_{Lr} is the number of receivers along the length Lr of the swarm and n_{Wr} is the number of receivers along the width Wᵣ of the swarm. Thus, the total number of receivers in the swarm is given by:

$${n}_{Lr} = \frac{{L}_{r}}{Δ r} , {n}_{Wr} = \frac{{W}_{r}}{Δ r} . \qquad ( 16 )$$

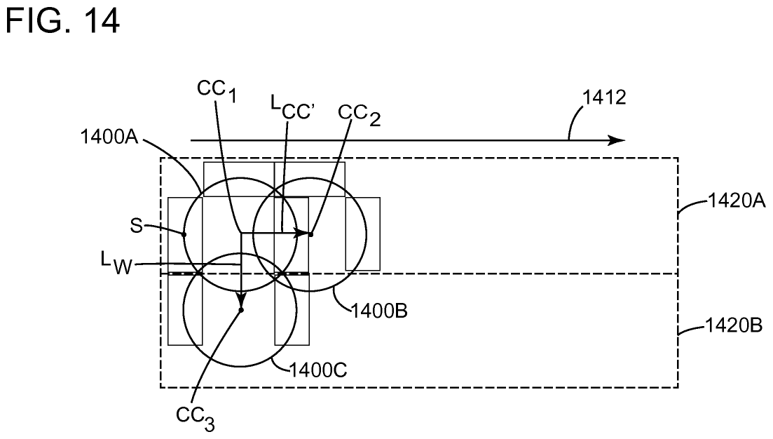

Another parameter that may be calculated for the coil-shooting straight line-recording marine system is the lateral shift L_{cc} of the center of turn followed by the source to the next center of turn, along the traveling direction of the receiver. FIG. 14 shows a source S following a first turn 1400A and the receiver moving along direction 1412. After the first turn 1400A is fully shot by the source S, the source moves to a second turn 1400B. The distance L_{cc} between the center CC₁ of the first turn 1400A and the center CC₂ of the second turn 1400B is calculated to be equal to the length of the swarm, i.e.,

$${L}_{cc} = 2 π {R}_{a} \frac{{v}_{r}}{{v}_{s} - {v}_{r}} . \qquad ( 17 )$$

FIG. 14 shows the two turns 1400A and 1400B located in a same current swath 1420A. When the source and receivers have covered the entire current swath 1420A, they need to move to a next swath 1420B for acquiring the seismic data. The distance L_{w} between the center CC₁ of the turn 1400A in the current swath 1420A and the center CC₃ of the turn 1400C in the next swath 1420B may be equal to L_{cc}, which is also given by equation (17).

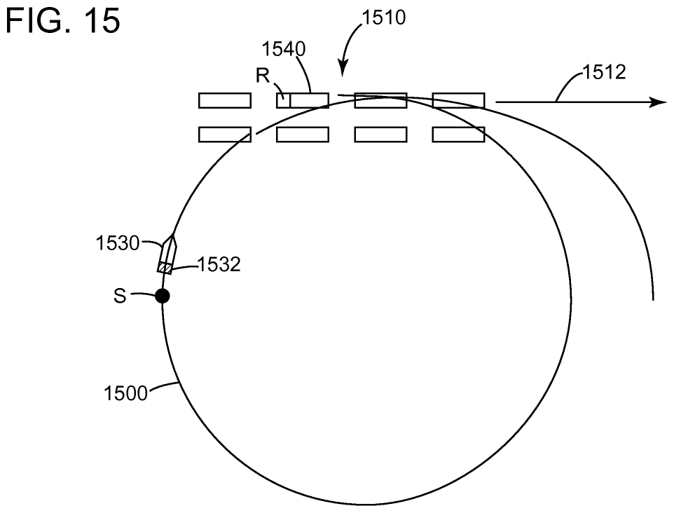

To calculate and implement the optimized values of the above discussed parameters, a command and control system 1532 is used and this system may be deployed on the vessel 1530 that tows the source S along overlapping curved sail path 1500. FIG. 15 also shows plural AUVs 1540, each carrying a corresponding seismic receiver R. Note that receiver straight line 1512, i.e., the path followed by the receivers or swarm of receivers, is tangent not only to a single turn of the overlapping curved sail path 1500, but to at least two such turns. In one embodiment, the receiver straight line is tangent to all the turns of the overlapping curved sail path.

In one embodiment, system 1532 may be distributed between the source vessel 1530 and one or more of the AUVs 1540. In this case, system 1532 acts as a global controller and the control system of each AUV acts as local controllers. In one embodiment, it is possible to deploy the entire control system 1532 on a master AUV of the swarm 1510.

System 1532, whose components are discussed later, may be configured to tune the direction of the AUVs and their speed to fulfill various acquisition requirements as: illumination coverage (offset/azimuth), trace density, regularization capabilities (optimized compressive sensing), time efficiency, power efficiency (following changing currents), and AUV recovery efficiency.

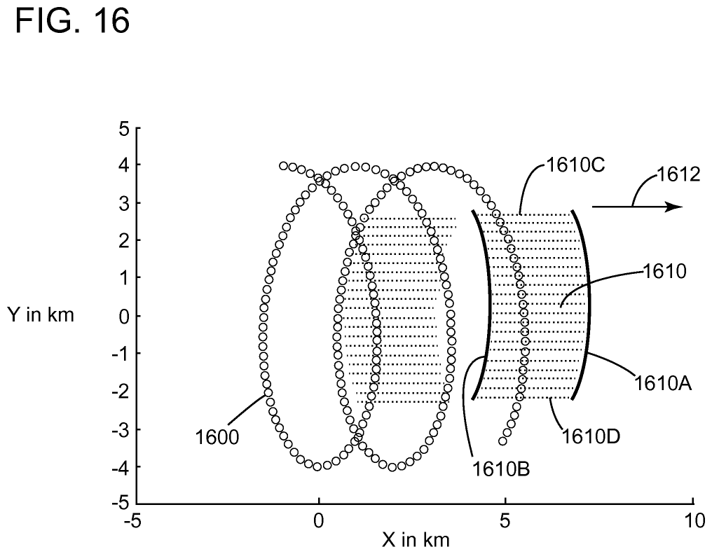

Although the previous embodiments have shown the swarms to have a box-like structure, e.g., rectangular, those skilled in the art would understand that other shapes are possible. For example, according to the embodiment illustrated in FIG. 16, swarm 1610 may have a curved shape along at least one side to fit the shape of the source path 1600 (which is curved). In other words, as the swarm 1610 move along direction 1612, two opposing sides 1610A and 1610B of the swarm are curved, having a given radius of curvature. The radius of curvature of the two sides may be the same or different. The radius of curvature of these sides of the swarm may be substantially (within 20%) the same as the radius of curvature of the source path 1600. However, these radii of curvatures may be different. Note that the other two sides 1610C and 1610D of the swarm may be straight lines. While FIG. 16 shows only one swarm, if more swarms are used, one or more of the swarms may have the curved shape.

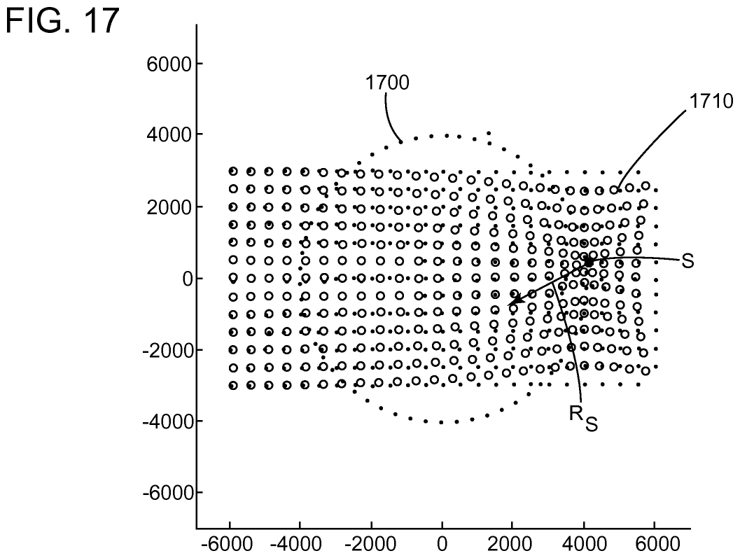

According to yet another embodiment illustrated in FIG. 17, the swarm 1710 may have a box-like shape like in FIG. 10, but the “density” of the receivers inside the swarm, which is shown to be constant and uniform in FIG. 10, changes. The term “density” is defined as the number of receivers per unit area. This change is determined by the position of the source S relative to the swarm. For example, as illustrated in FIG. 17, the receivers of the swarm, closest to the source, may be configured to move toward the source. This process is dynamic, i.e., the density of the receivers inside the swarm changes as the source moves relative to the swarm. In one application, the density of the receivers only close to the source, e.g., within a given radius Rₛ of the source, change while the density of the other receivers remains constant and uniform. This means, that the density inside the circle of radius Rₛ centered on the source S is larger than the density of the receivers elsewhere in the swarm. Although the location of the swarm in FIG. 17 is shown to be over the source path 1700, it is possible that the swarm 1710 is located outside path 1700.

The above embodiments have been discussed without specifying the details of the source, receivers or AUVs. In this regard, the source can be an impulsive source (e.g., an air gun), a vibratory source (e.g., the source described in U.S. Pat. No. 8,837,259, which is enclosed herein by reference), or any other source. The receiver may be a hydrophone, geophone, accelerometer, optical fiber, gravity detecting sensor, pressure gradient sensor, etc. The receiver may be one component (e.g., can determine a scalar quantity) or multi-component (e.g., can determine a vector).

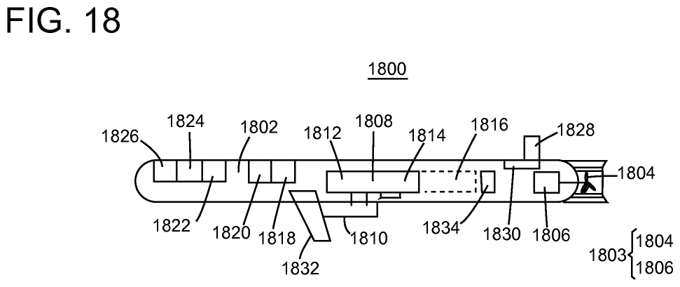

An AUV 1800 that is configured to carry the seismic receivers R is now discussed with regard to FIG. 18. AUV 1800 has a body 1802 in which a propulsion system 1803 may be located. The propulsion system 1803 may include, for example, one or more propellers 1804 and a motor 1806 for activating the propeller 1804. Alternatively, or in addition, the propulsion system may include adjustable wings for controlling a trajectory of the AUV. The motor 1806 may be controlled by a processor 1808. The processor 1808 may also be connected to a seismic sensor 1810. The seismic sensor may include one or more of a hydrophone, geophone, accelerometer, etc. For example, if a 4C (four component) survey is desired, the seismic sensor 1810 includes three accelerometers and a hydrophone, i.e., a total of four sensors. Alternatively, the seismic sensor may include three geophones and a hydrophone. Of course, other sensor combinations are possible.

A memory unit 1812 may be connected to the processor 1808 and/or the seismic sensor 1810 for storing seismic data recorded by the seismic sensor 1810. A battery 1814 may be used to power all these components. The battery 1814 may be allowed to shift its position along a track 1816 to change the AUV's center of gravity.

The AUV may also include an inertial navigation system (INS) 1818 configured to guide the AUV to a desired location. An inertial navigation system includes at least a module containing accelerometers, gyroscopes or other motion-sensing devices. The INS is initially provided with the current position and velocity of the AUV from another source, for example, a human operator, a GPS satellite receiver, another INS from the vessel, etc., and thereafter, the INS computes its own updated position and velocity by integrating (and optionally filtrating) information received from its motion sensors. The advantage of an INS is that it requires no external references in order to determine its position, orientation or velocity once it has been initialized. Further, using an INS is inexpensive.

Besides or instead of the INS 1818, the AUV may include a compass 1820 and other sensors 1822 as, for example, an altimeter for measuring its altitude, a pressure gauge, an interrogator module, etc. The AUV 1800 may optionally include an obstacle avoidance system 1824 and a communication device 1826 (e.g., Wi-Fi or other wireless communication) or other data transfer device capable of wirelessly transferring seismic data. In one embodiment, the transfer of seismic data takes place while the AUV is on a mother vessel. Also, it is possible that the communication device 1826 is a port wire-connected to the vessel to transfer the seismic data. One or more of these elements may be linked to the processor 1808. The AUV further includes an antenna 1828 (which may be flush with the AUV's body) and a corresponding acoustic system 1830 for communicating with the deploying, recovery or shooting vessel or another vehicle. Stabilizing fins and/or wings 1832 for guiding the AUV to the desired position may be used with the propulsion system 1803 for steering the AUV. However, in one embodiment, the AUV has no fins or wings. The AUV may include a buoyancy system 1834 for controlling the AUV's depth as will be discussed later.

The acoustic system 1830, which may be also present on the mother vessel for determining the AUV's position, may be an Ultra-Short Baseline (USBL) system, also sometimes known as Super Short Base Line (SSBL), which uses a method of underwater acoustic positioning. A complete USBL system includes a transceiver mounted on a pole under the mother vessel, and a transponder/responder on the AUV. It also may include a depth sensor (not shown) and/or a heading sensor (not shown) for reducing the ambiguity generated by the acoustic system 1830. A processor is used to calculate the AUV's position from the ranges and bearings the transceiver measures and also the depth or/and heading information. The processor may be located on the AUV or the mother vessel. For example, the transceiver transmits an acoustic pulse that is detected by the subsea transponder, which replies with its own acoustic pulse. This return pulse is detected by the transceiver on the vessel. The time from transmission of the initial acoustic pulse until the reply is detected is measured by the USBL system and converted into a range. To calculate a subsea position, the USBL calculates both a range and an angle from the transceiver to the subsea AUV. Angles are measured by the transceiver, which contains an array of transducers. The transceiver head normally contains three or more transducers separated by a baseline of, e.g., 10 cm or less. The AUV 1800 illustrated in FIG. 18 is exemplary. Other AUVs may be used.

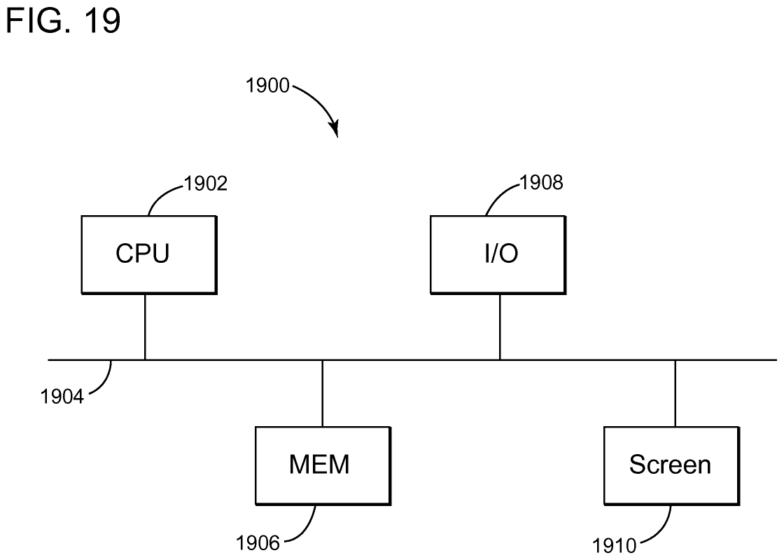

A computing device that may implement one or more of the methods discussed above are now discussed with regard to FIG. 19. This computing device may be the general controller 1532 previously discussed or a local controller of the AUV. Computing device 1900 includes a processor 1902 that is connected through a bus 1904 to a storage device 1906. Computing device 1900 may also include an input/output interface 1908 through which data can be exchanged with the processor and/or storage device. For example, a keyboard, mouse or other device may be connected to the input/output interface 1908 to send commands to the processor and/or to collect data stored in storage device or to provide data necessary to the processor. Also, the processor may be used to process, for example, seismic data collected during the seismic survey. Results of this or another algorithm may be visualized on a screen 1910, which may not be part of device 1900.

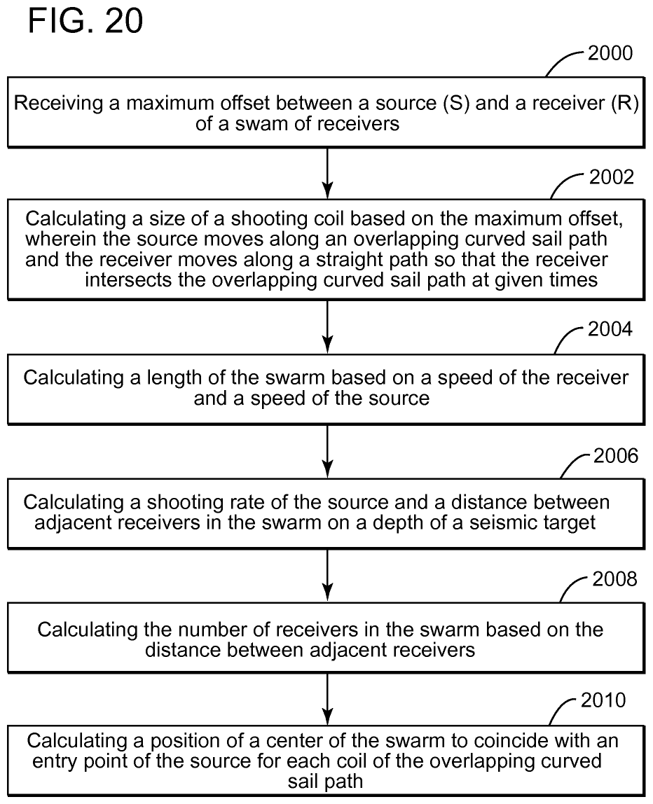

A method for designing a geometry of a marine acquisition system for performing a marine seismic survey is now discussed with regard to FIG. 20. The method includes a step 2000 of receiving a maximum offset between a source and a receiver of a swarm of receivers, a step 2002 of calculating a size of a shooting coil based on the maximum offset, where the source moves along an overlapping curved sail path and the receiver moves along a straight path so that the receiver intersects the overlapping curved sail path at given times, a step 2004 of calculating a length of the swarm based on a speed of the receiver and a speed of the source, a step 2006 of calculating a shooting rate of the source and a distance between adjacent receivers in the swarm based on a depth of a seismic target, a step 2008 of calculating the number of receivers in the swarm based on the distance between adjacent receivers, and a step 2010 of calculating a position of a center of the swarm to coincide with an entry point of the source for each turn of the overlapping curved sail path.

The method may also include a step of repeating the above calculations for another swarm of receivers, or/and a step of selecting the straight path to be oriented along ocean currents. The method may also include selecting a boundary of the swarm to have two sides substantially parallel with a part of the overlapping curved sail path, or/and calculating a distance between centers of adjacent turns in a same swath of the overlapping curved sail path as a function of the speed of the receiver and a speed of the source; and calculating a distance between centers of adjacent turns in different swaths of the overlapping curved sail path as a function of a speed of the receiver and a speed of the source.

One or more of the embodiments discussed above disclose a coil-shooting source that works in tandem with one or more receivers that move along a line that is tangent to the source's path. It should be understood that this description is not intended to limit the invention. On the contrary, the embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A marine seismic acquisition system comprising:
an acoustic source towed along an overlapping curved sail path and configured to generate acoustic waves;
a first underwater vehicle, UV, that moves along a receiver straight path; and
a first seismic receiver attached to the first UV and configured to record the acoustic waves generated by the acoustic source,
wherein a receiver position along the straight path is substantially coincident with the overlapping curved sail path at given times.

2. The system of claim 1, wherein the overlapping curved sail path includes plural turns.

3. The system of claim 2, wherein the plural turns are not circles.

4. The system of claim 2, wherein the receiver straight path is tangent to two or more of the plural turns.

5. The system of claim 1, further comprising:
a second UV having a second seismic receiver, the second UV moving along the same receiver straight path as the first UV and the first and second UVs forming a line which is tangent to the overlapping curved sail path.

6. The system of claim 1, further comprising:
plural second UVs having corresponding plural second seismic receivers, the first UV and the second plural UVs forming a first swarm and the first swarm having a length L that becomes tangent to the overlapping curved sail path at a given time.

7. The system of claim 6, wherein a boundary of the first swarm is defined by a rectangle.

8. The system of claim 6, wherein a boundary of the first swarm is defined by two straight lines and two curved lines.

9. The system of claim 6, wherein a density of the second UVs inside the first swarm, when deployed in water, is a given constant, and the density dynamically increases during the seismic survey, for a subset of the second UVs that are inside a circle having a given radius and the circle being centered on the source.

10. The system of claim 6, wherein the length L of the first swarm is calculated based on a speed of the first receiver and a speed of the source so that a position of a center of the first swarm coincides with a position of the source any time when the source enters a new turn of the overlapping curved sail path.

11. The system of claim 6, wherein a radius of a turn of the overlapping curved sail path is calculated to be equal to a given maximum offset between the first receiver and the source.

12. The system of claim 6, wherein a distance between centers of adjacent turns in a same swath of the overlapping curved sail path is selected to be a function of the speed of the receiver and a speed of the source.

13. The system of claim 6, wherein a distance between centers of adjacent turns in adjacent swaths of the overlapping curved sail path is selected to be a function of a speed of the receiver and a speed of the source.

14. The system of claim 6, further comprising:
second, third and fourth swarms,
wherein the first to fourth swarms are symmetrically distributed along a given turn of the overlapping curved sail path, and
wherein a position of each of the four swarms is calculated so that a center of the respective swarm intersects the source that moves along the given turn of the overlapping curved sail path.

15. A method for selecting a geometry of a marine acquisition system for performing a marine seismic survey, the method comprising:
receiving a maximum offset between a source and a receiver of a swarm of receivers;
calculating a size of a shooting turn based on the maximum offset, wherein the source moves along an overlapping curved sail path and the receiver moves along a straight path so that the receiver intersects the overlapping curved sail path at given times;
calculating a length of the swarm based on a speed of the receiver and a speed of the source;
calculating a shooting rate of the source and a distance between adjacent receivers in the swarm based on a depth of a seismic target;
calculating the number of receivers in the swarm based on the distance between adjacent receivers; and
calculating a position of a center of the swarm to coincide with an entry point of the source for each turn of the overlapping curved sail path.

16. The method of claim 15, further comprising:
repeating the above calculations for another swarm of receivers.

17. The method of claim 15, further comprising:
selecting the straight path to be oriented along ocean currents.

18. The method of claim 15, wherein the receiver straight path is tangent to two or more turns of the overlapping curved sail path.

19. The method of claim 15, further comprising:
selecting a boundary of the swarm to have two sides substantially parallel with a part of the overlapping curved sail path.

20. The method of claim 15, further comprising:
calculating a distance between centers of adjacent turns in a same swath of the overlapping curved sail path to be a function of the speed of the receiver and a speed of the source; and
calculating a distance between centers of adjacent turns in adjacent swaths of the overlapping curved sail path to be a function of a speed of the receiver and a speed of the source.
